(19) United States
(12) Patent Application Publication
(10) Pub. No.: US 2007/0276704 A1
(43) Pub. Date: Nov. 29, 2007

(54) System and Method for Providing Insurance Data

(76) Inventors: Peter J. Naumann, Minneapolis, MN (US); John P. Reinke, Edina, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/567,115

(22) Filed: Dec. 5, 2006

Related U.S. Application Data
(60) Provisional application No. 60/742,538, filed on Dec. 5, 2005.

(51) Int. Cl. G06Q 40/00

(52) U.S. Cl. 705/4

(57) ABSTRACT

A method for providing insurance data includes storing one or more service events, where each service event is associated with one or more medical encounters and with enrollee responsibility data, receiving medical encounter data from a user, identifying the service event associated with the medical encounter data received from the user, and providing to the user the enrollee responsibility data associated with the identified service event. A system for providing insurance data includes a database configured for storing one or more service events, where each service event is associated with one or more medical encounters and with enrollee responsibility data, a processor configured for retrieving data associated with the one or more service events; and a plurality of user terminals for receiving the retrieved data.

### CROSS-REFERENCE TO RELATED APPLICATION(S)

The present invention claims priority to U.S. Provisional Patent Application No. 60/742,538, filed on Dec. 5, 2005, which is herein incorporated by reference in its entirety.

### FIELD OF THE INVENTION

The present invention relates to providing insurance data having service events and associated enrollee responsibilities that may be implemented for use with insurance applications.

### BACKGROUND

Delivering benefit plans to consumers involves manual and labor-intensive end-to-end sales and implementation processes. Benefit plan and product data may be incorrect or difficult to interpret into downstream platforms, and customer options may be incorrect at the time of sale. Once a benefit plan is sold, plan information may be required on multiple platforms and therefore may need to be re-keyed several times. In addition, a lack of common standards for insurance data may cause difficulties in translating information between the multiple platforms.

### SUMMARY

A system and method provide insurance data using a table-driven constraint-based approach that includes service events and associated enrollee responsibilities. A service event is composed of any number of medical encounters, each of which have the same enrollee responsibility, e.g. the same enrollee copay or coinsurance. Service events and associated enrollee responsibility data may remain relatively stable, while the medical encounters grouped in each service event may be increased or decreased. However, service events are also modifiable and expandable to reflect requirements of an insurance company and of the healthcare industry. Service events may be implemented in various systems and may be used for configuring, characterizing, comparing and querying insurance products.

A service event and associated enrollee responsibility data has a number of medical encounters assigned to it. The medical encounters may be represented as a number of codes corresponding to services provided (e.g., CPT and diagnosis codes), the reason the service was provided (e.g., for diagnostic or screening purposes), where the service was provided (e.g., POS), and who provided the service (e.g., a doctor, nurse, physical therapist). The medical encounter codes stored in the service event may be the same codes as are found in insurance claims, and as a result, retrieving enrollee responsibility data for insurance claims may be simplified because locating a matching code in one of the service events enables enrollee responsibility data to be retrieved.

According to one implementation, a method for providing insurance data includes storing one or more service events, where each service event is associated with one or more medical encounters and with enrollee responsibility data; receiving medical encounter data from a user; identifying the service event associated with the medical encounter data received from the user; and providing to the user the enrollee responsibility data associated with the identified service event.

According to another implementation, a method for generating an insurance product includes storing one or more service events, where each service event is associated with one or more medical encounters and with enrollee responsibility data; storing one or more insurance product templates, where each template is associated with the one or more service events for a user to select; providing the user with access to the one or more insurance product templates and the one or more service events; receiving service event selection data from the user; and generating one or more insurance products using the service event selection data.

In another implementation, a method for characterizing an insurance product includes storing one or more service events, where each service event is associated with one or more medical encounters and with enrollee responsibility data; receiving insurance plan data; characterizing the insurance plan data using the one or more service events; and providing the characterized insurance plan data to a user.

According to one configuration, a system for providing insurance data includes a database configured for storing one or more service events, where each service event is associated with one or more medical encounters and with enrollee responsibility data; a processor configured for retrieving data associated with the one or more service events; and a plurality of user terminals for receiving the retrieved data.

The system and method for providing an insurance data structure may apply to other types of insurance in addition to or as an alternative to health insurance, such as life, disability, liability, or property insurance.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWINGS

FIG. 1A is a flowchart of a method for providing insurance data.

FIG. 1B is a flowchart of a method for generating an insurance product.

FIG. 1C is a flowchart of a method for characterizing an insurance product.

FIG. 2A is an illustration of a service event data in an optional insurance data hierarchy.

FIG. 2B provides a representative chart of covered health services by group.

FIG. 2C provides an exemplary portion of an insurance data structure for the home health care covered health services.

FIG. 3 provides an exemplary data structure for the ambulance and transportation covered health service.

FIG. 4 is a hierarchy depicting a health services inventory for the diabetes services covered health service.

FIG. 5 is a diagram of an exemplary system for providing a product benefit database.

FIG. 6 provides an illustration of a product offering template and its various components.

FIG. 7 provides an exemplary screenshot of a benefit query user interface.

### DETAILED DESCRIPTION

The following description relates to systems and methods for providing user with health insurance data. Health insurance data may include insurance data for medical, dental, and/or vision products and services, or other health-related products and services. However, it should be understood that insurance data may be provided for a variety of insurance industries such as the disability, liability, life, property, and/or automotive insurance industries.

A system and method are provided for configuring insurance data by generating an inventory of service events that are designed according to insurance industry requirements, customer requirements, internal business needs, and state and federal mandates. Service events may be defined by procedure, diagnosis, place of service, and provider type data; and each service event is associated with enrollee responsibility data. Each service event may be considered a receptacle for holding a number medical codes and revenue codes, where each of the number of codes held in the service event is associated with the same enrollee responsibility (e.g., the same copay, coinsurance, deductible, out of pocket maximum, etc.). The medical and revenue codes associated with the service event data are the same as the codes that may be found in an insurance claim. Thus, when claims are submitted from a provider or facility that include CMS codes (ICD-9, HCPCS, Medicare and Medicaid codes), AMA codes (CPT codes), and/or revenue codes, the service event having the same code or codes may be located, along with the associated enrollee responsibility.

Service events (SEs) are designed around defining medical coverage using a finite set of terms. This is beneficial to insurers, providers, and members, because hundreds of thousands or even millions of various permutations of codes for medical encounters are available, and more may be generated as the number of CMS, AMA and revenue codes increase. Thus, defining a finite number of SEs, into which medical encounters may be categorized, simplifies insurance claims processing and other claim-related functions; and improves the accuracy of clinical analysis, underwriting, consultative sales processes with customers for benefit plan design, fraud detection and several other insurance business processes.

In addition, the medical encounter codes within the finite number of SEs may be easily updated, changed, and removed and placed into another service event. For example, when a medical encounter code associated with a vaccination originally is considered to be an experimental procedure, the code may be stored in an experimental procedure SE. If the vaccination is no longer considered experimental, for example, due to changes in the medical industry, the SE administrator may move the vaccination medical encounter code to an appropriate vaccination SE, such as an adult or adolescent vaccination SE. When the procedure changes from one SE to another, the enrollee responsibility designation changes to the enrollee responsibility associated with the new SE. Thus, continuing with the vaccine example, when the vaccine is categorized as experimental and is associated with an experimental procedure SE, the enrollee responsibility may be 100% or not covered by the insurance company, and when the vaccine categorization is changed so that it is associated with an adolescent or adult vaccination SE, the enrollee responsibility may be a copay, coinsurance, and may be associated with limits and out of pocket maximums.

In addition, SEs may be arranged to accommodate various state mandates. State mandates often provide different levels of coverage than specified in a standard insurance plan. By tying the mandated provisions to the affected service events, insurance companies are able to ensure compliance with mandated benefits in each state, and can easily determine the impact of mandated benefits on the cost of coverage for a benefit plan.

The enrollee responsibility associated with a given SE may be given as a range of responsibility, such as an enrollee copay range, an enrollee deductible range, or an enrollee out of pocket maximum range. Alternatively, the enrollee responsibility may be given as a particular enrollee copay, deductible, or out of pocket maximum. Furthermore, for some SEs, enrollee responsibilities may be 100% when the insurance company does not cover medical expenses. For example, an insurance company may not provide coverage for elective cosmetic surgery, and the enrollee may be responsible for 100% of the cost.

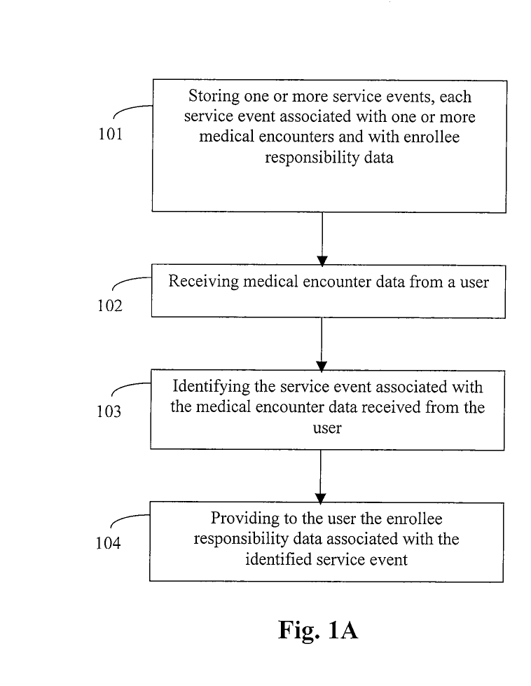

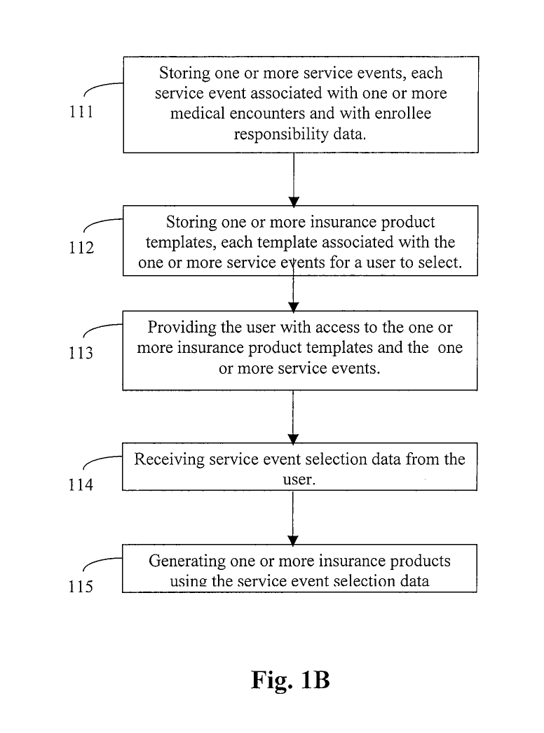

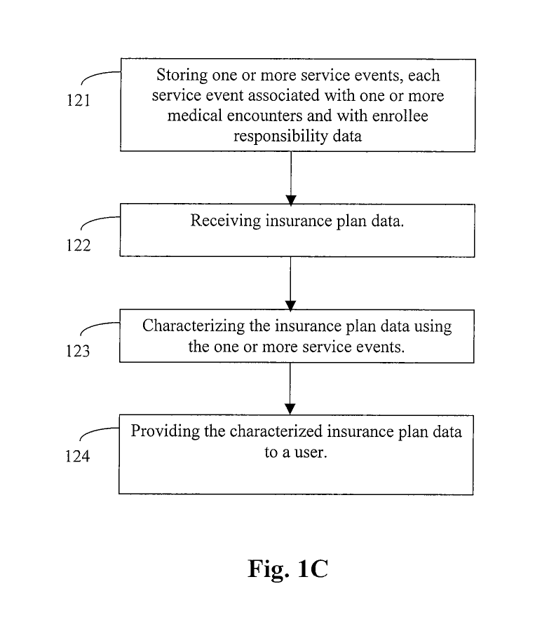

FIG. 1A is a flowchart of a method for providing insurance data useful for a number of applications and includes storing 101 one or more service events, where each service event is associated with one or more medical encounters and with enrollee responsibility data; receiving 102 medical encounter data from a user; identifying 103 the service event associated with the medical encounter data received from the user; and providing 104 to the user the enrollee responsibility data associated with the identified service event. The method for providing insurance data may be useful in applications such as insurance plan queries from enrollees inquiring about their payment responsibilities.

FIG. 1B is a flowchart of a method for generating insurance products using service event data from an insurance data structure. The method includes storing 111 one or more service events, where each service event is associated with one or more medical encounters and with enrollee responsibility data; storing 112 one or more insurance product templates, where each template associated with the one or more service events for a user to select; providing 113 the user with access to the one or more insurance product templates and the one or more service events; receiving 114 service event selection data from the user; and generating 115 one or more insurance products using the service event selection data. The method for generating insurance products may be useful for insurance companies that engineer insurance plans.

FIG. 1C is a flowchart of a method for characterizing insurance products using service event data from an insurance data structure. The method includes storing 121 one or more service events, where each service event is associated with one or more medical encounters and with enrollee responsibility data; receiving 122 insurance plan data; characterizing 123 the insurance plan data using the one or more service events; and providing 124 the characterized insurance plan data to a user. The method for characterizing insurance products may be useful for insurance companies and consumers that have data on existing insurance plans but that haven't been developed from the insurance data structure having the service event data. The pre-existing data may be analyzed and characterized according to the service event data so that enrollee responsibility data may be easily understood, or so that a comparison of the characterized data with other plans defined from service events may be made.

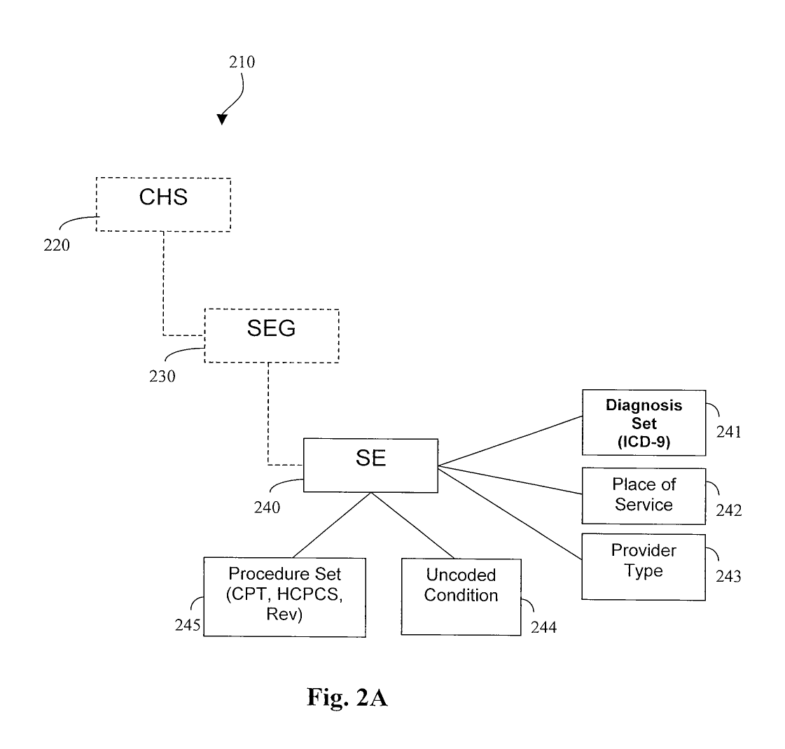

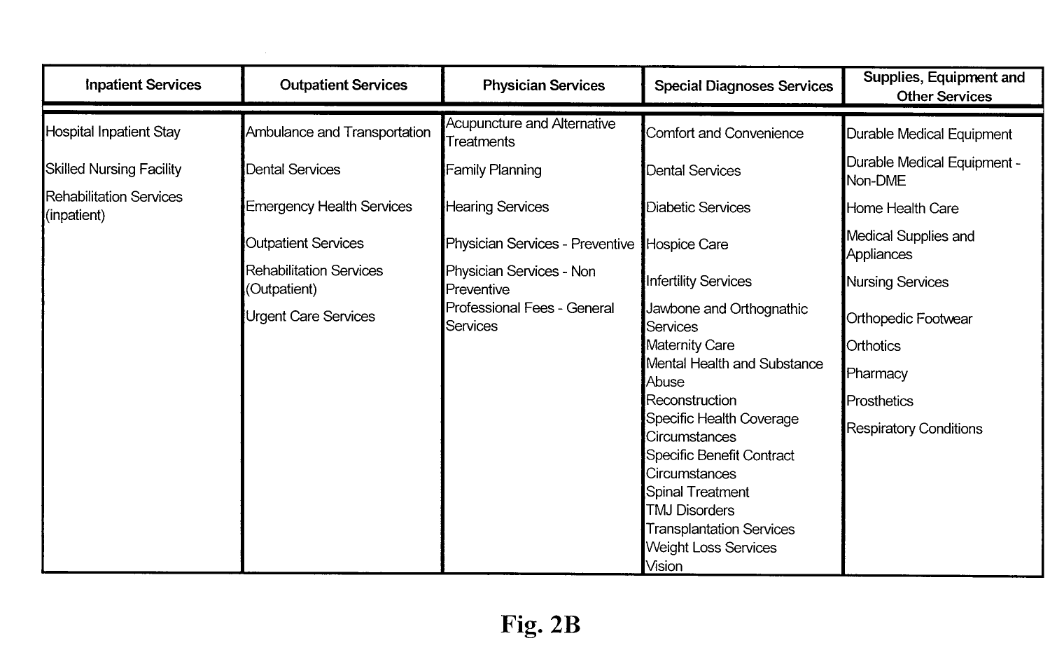

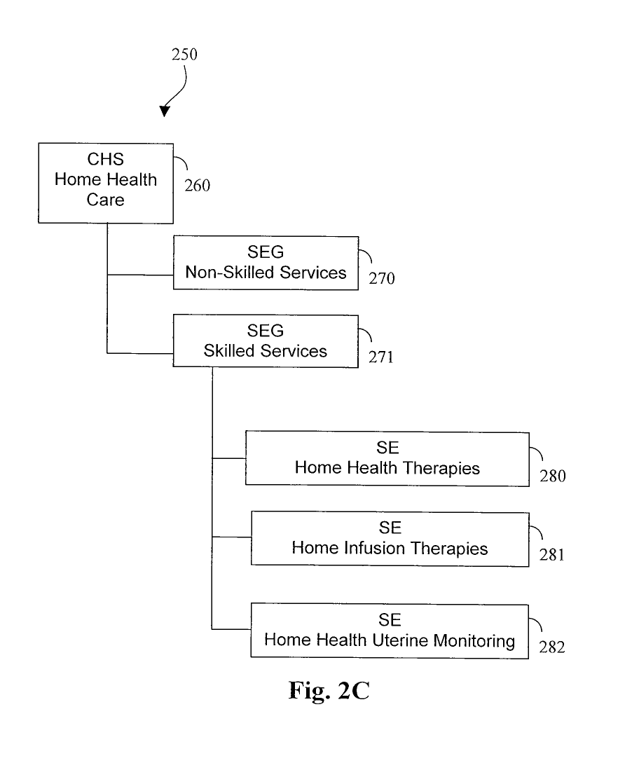

According to certain implementations, service events may be grouped into a data structure or a hierarchy. For example, service events may be grouped in a health insurance data hierarchy that, at a lower granular level, represents a finite number of service events, at a top level, represents broad covered health services, and at intermediate levels includes an arbitrary number of levels for logically grouping service events and the other intermediate levels. FIG. 2A is an illustration of a logical hierarchy 210 for health insurance benefits according to certain implementations. At the uppermost level, the health insurance data hierarchy optionally includes one or more covered health services (CHS) 220 that may be based on types of coverage available in the industry and/or from the insurer, and may be defined according to certificate of coverage data or other data relating to general benefit certificates.

FIG. 2B provides a representative chart of CHSs by group. For example, CHSs in the outpatient services group include ambulance and transportation, dental services, emergency health services, outpatient services, rehabilitation services, and urgent care services.

Returning to FIG. 2A, for each CHS 220, nodes leading to one or more optional service event groups (SEG) 230 may be provided. SEGs may be divided by type of equipment or supply, place of service, method or category of service, condition or cause required for benefits or individual coverage differences.

For example, and as depicted in the hierarchy 250 of FIG. 2C, SEGs for the home health care CHS 260, include the non-skilled services SEG 270 and skilled services SEG 271. In another example, SEGs for a durable medical equipment CHS include the beds SEG, the infusion supplies SEG and the oxygen supplies SEG.

Associated with each SEG is one or more service events (SE) 240. Each SE is associated with an enrollee responsibility and holds or groups medical encounter codes such as procedure set codes, e.g., CPT and HCPCS codes, or includes branches to nodes for medical encounter codes such as procedure set 245, provider type 243, diagnosis 241, place of service 242 codes, and data related to uncoded conditions 244, as depicted in FIG. 2A.

SEs may have various permutations and may be divided by specific type of service or procedure, specific item or supply, specific diagnosis or condition, mandated coverage and/or code type. For example, in FIG. 2C, SEs for the skilled services SEG 271 include the home health therapies SE 280, the home infusion therapies SE 281 and home health uterine monitoring services SE 282, and thus the SEs are divided according to the different home therapies and services. Each SE may hold a number of associated medical encounter codes. The home health therapies SE 280 may include codes associated with home nursing therapies, home physical therapies, and home rehabilitation, and at least one commonality among the therapies grouped within the home health therapies SE 280 is that they are associated with the same enrollee responsibility.

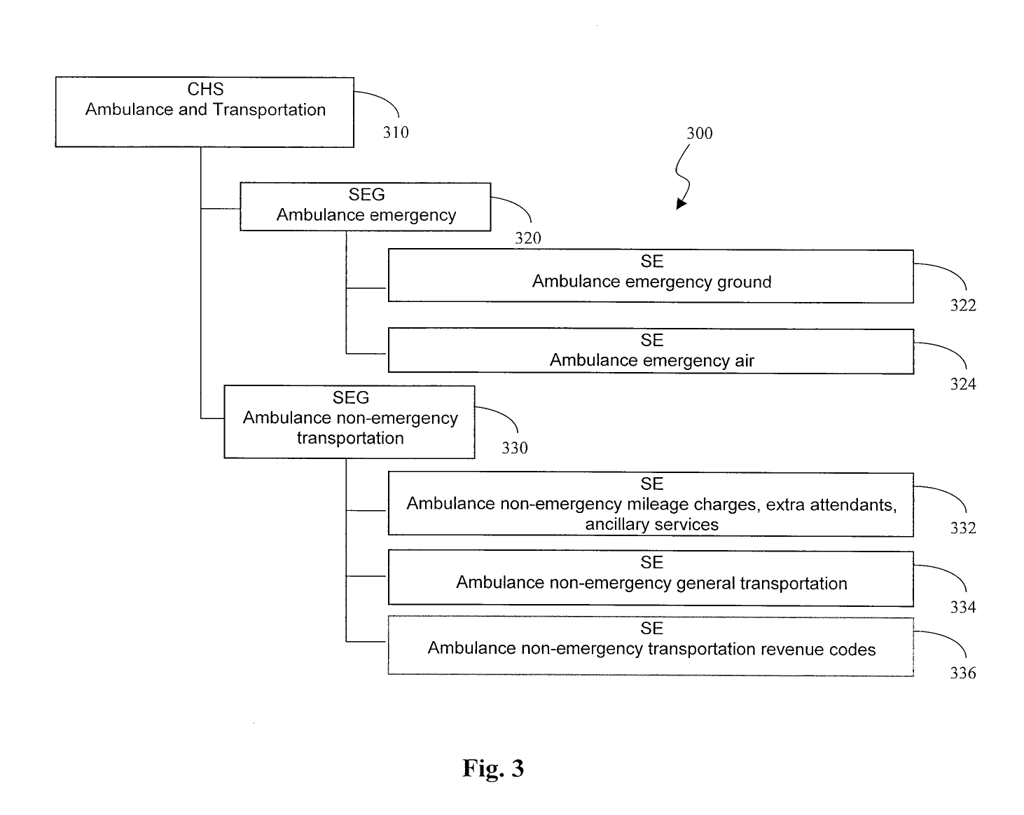

In another example, an insurance data structure is represented in FIG. 3 that provides an exemplary data structure 300 of the ambulance and transportation CHS. According to FIG. 3, the ambulance and transportation CHS 310 includes branches leading to two SEG nodes, the ambulance emergency SEG 320 and the ambulance non-emergency transportation SEG 330. SE nodes are associated with each SEG 320, 330. For the ambulance emergency SEG 320, branches lead the ambulance emergency ground SE 322, and to the ambulance emergency air 324. For the ambulance non-emergency transportation SEG 330, branches lead to the ambulance non-emergency mileage charges, extra attendants ancillary services SE 332, the ambulance non-emergency general transportation SE 334, and to the ambulance non-emergency transportation revenue codes SE 336. Each SE may hold a number of codes related to medical encounters that are found in insurance claims, and the codes are grouped into the appropriate SE based on the associated enrollee responsibility.

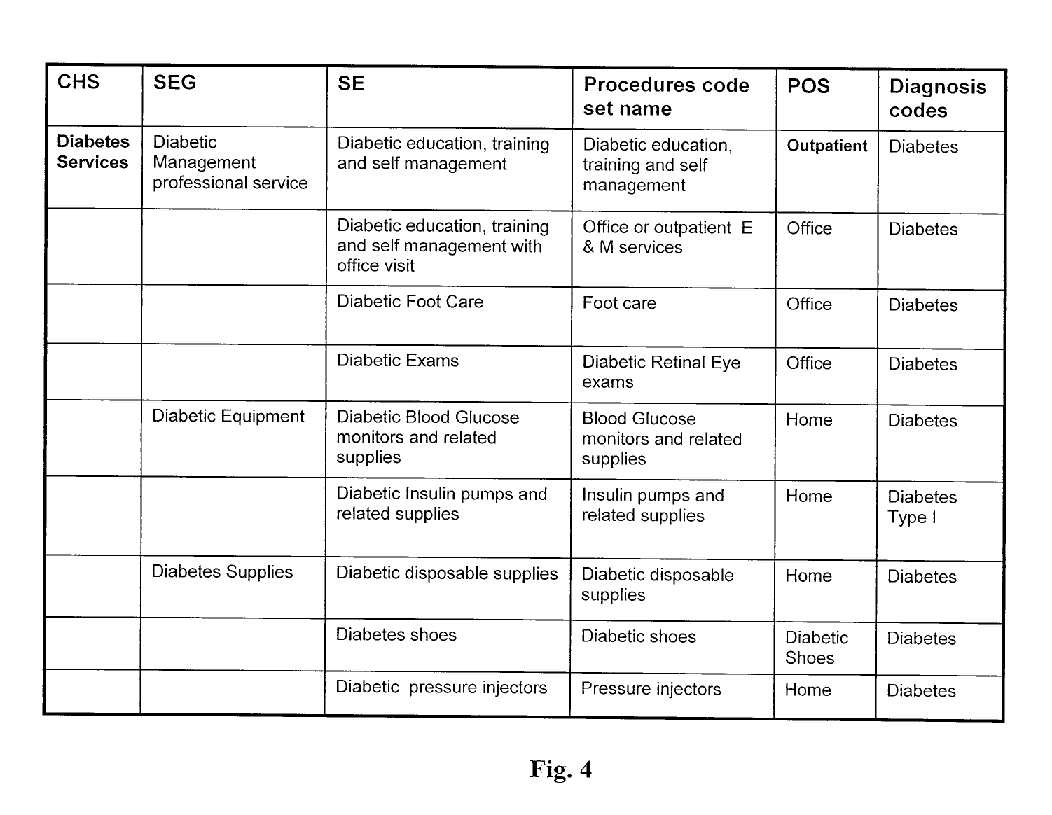

According to further implementations, a portion of the insurance data structure may be provided in a table format in addition to or as an alternative to the tree format of FIG. 3. For example, a table depicting a health services inventory for the diabetes services CHS is depicted in FIG. 4. According to FIG. 4, the diabetes services CHS includes three service event groups having 9 total service events. Each service event is associated with a number of medical encounters, and in FIG. 4, each service event includes a procedure code set name, place of service data, and diagnosis codes.

It will be understood that although the above-described portions of the insurance data structures include text describing medical encounters, the data also may be represented by codes, such as ICD, HCPCS, or CPT codes. The above examples are illustrative only, and an insurance data structure may be defined as desired according to various system implementations or uses.

According to a particular embodiment, an insurance data structure includes approximately 1500 service events that represent a collection of specific claim scenarios, and into which the permutations of valid medical encounters, and their associated codes, may be grouped. The approximately 1500 SEs may be grouped together under about 50 covered health services that have definitions closely related to industry standards and/or terms commonly known in the health insurance industry, e.g., terms derived from COCs. In one example, each CHS may be associated with between 1 and 50 SEs. The number of SEs may be increased or decreased. However, service events may remain stable while their contents are modified on a periodic basis. For example, SEs may be modified to include new codes each time the AMA and/or the CMS issue new codes.

The above-described insurance data structure may be used in applications associated with insurance products. For example, the service events in the data structure may be used to characterize health insurance plans. Characterized plans may be easily compared regardless of the origin of the plan, e.g., regardless of the insurance company, because each characterization is based on the same data structure. A processor and database containing the insurance data structure also may be queried in order to search for enrollee responsibilities, plan benefits, or plan information. In another example, the insurance data structure may facilitate claims processing because the codes held in the various SEs may be the same as the codes submitted in provider or facility claims.

According to various implementations, the insurance data structure that at least includes service events and their associated data is included in a product benefit processor and database (PBD). A PBD is a collection of applications and services for gathering, storing, distributing and processing product-related information, in which all or a portion of the product-related information is based off of the insurance data structure. In some implementations, the PBD and its insurance data structure may be communicatively coupled with a variety of insurance product tools.

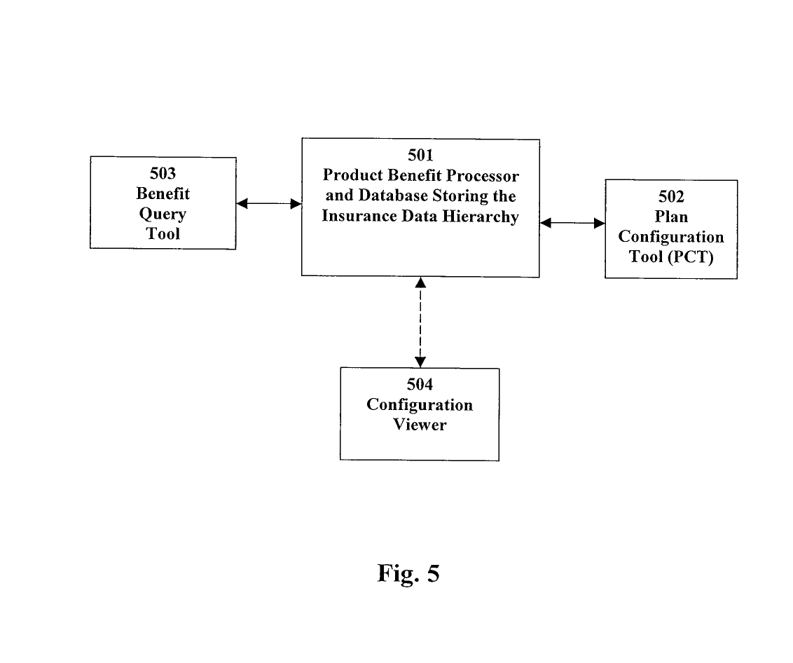

FIG. 5 is a diagram of an exemplary system for providing a PBD 501 and its associated components. According to FIG. 5, PBD 501 with its insurance data structure is communicatively coupled to a plan configuration tool (PCT) 502, and a benefit query tool 503. In addition to being communicatively coupled to components 502-503, the PBD 501 with its insurance data structure houses extracted and transformed claims data, customer plan configurations. It should be understood that one or more of the components 502-503 associated with PBD 501 may be integrated with PBD. Further, other components in addition to components 502-503 may be associated or integrated with PBD.

The PBD 501 is configured to store, revise, and update the insurance data structure, and particularly the service events, so that the service events are defined by and include the most current information on industry codes and new products, mandates, and filings. In addition, PBD 501 stores product templates and conditions and constraints, both of which are described below. In some implementations, PBD 501 houses a portion of the insurance data structure that includes at least the SEs and CHSs, and their respective associated data. Product templates in PBD 501, such as product offering templates, may be configured to become specific customer benefit plans once completed with data from the insurance data structure, associated codes, and benefit coverage, and may be designed to reflect state mandates and filed ranges. Conditions and constraints in PBD 501 are requirements associated with generating product templates in order to result in a customer plan that is compliant with government regulations and mandates and/or business constraints. Each of the insurance data structure, the product templates, and conditions and constraints may be used by the other components 502-503 in order to create or search for insurance products.

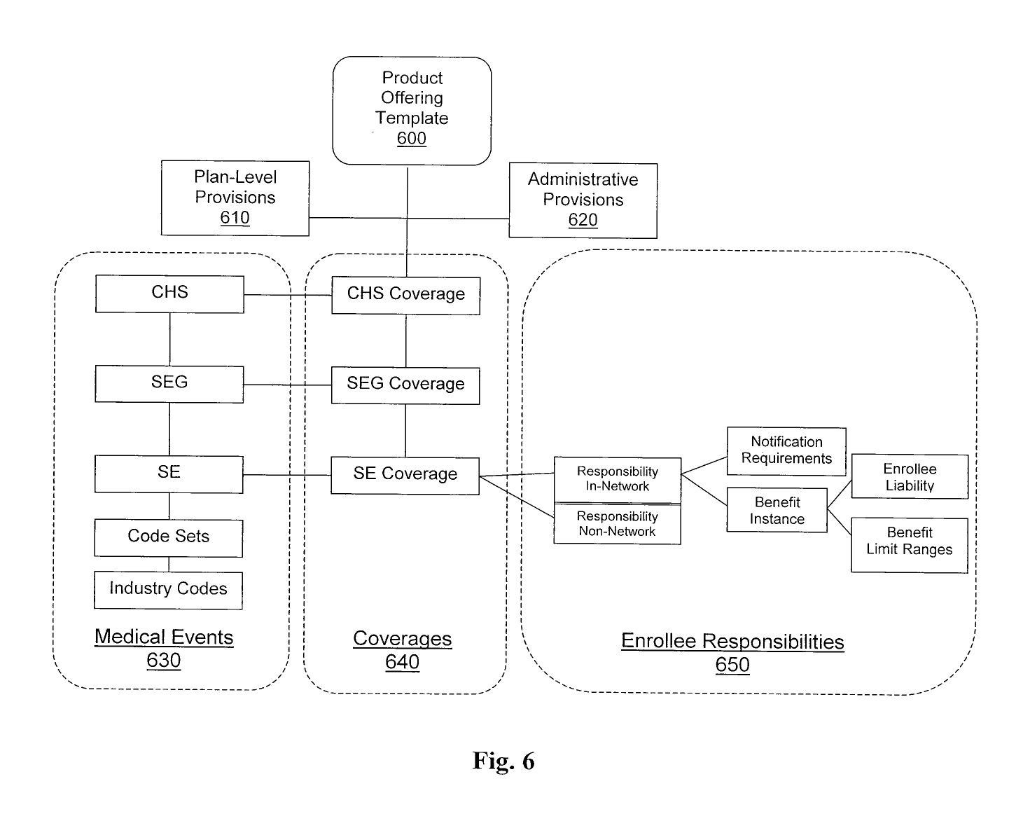

FIG. 6 provides an illustration of a product offering template 600 from PBD 501, and the various components of the product offering template. According to FIG. 6, the five portions of the product offering template 600 include “Plan-Level Provisions” 610, “Administrative Provisions” 620, “Medical Events” 630, “Coverages”640, and “Enrollee Responsibilities” 650. The CHS, SEG, and SE of “Medical Events” 630 each include associated coverages in “Coverages” 640, and the SE of “Coverages”640 include associated enrollee responsibilities in “Enrollee Responsibilities” 650. Product offering templates provide an association between SEs and a collection of allowable values, e.g., enrollee responsibilities. Building a product using a product offering template constrains a user to choose from an allowed list of values and SEs for a particular product. Product offering templates may be configured so that a user is presented with allowed values that are determined by internal medical policies and state mandated benefits. For example, a user may select a medical insurance policy template and be presented with an allowed list of values available for selection under the medical insurance policy template according to state mandated benefits. When an insurance rider template is selected, a user may be presented with a list of values available for selection under the insurance rider template according to internal medical policies.

Returning to FIG. 5, PCT 502 is a tool that uses the insurance data structure to support functions such as determining plan availability, assisting in plan selection, and generating consumer plans. Using PCT 502, a user may search for product offering templates that can be configured for customer plans, add and modify customer plan information, configure details of benefit data included in an employer benefit package, and generate customer plans by combining templates and service event data from the insurance data structure according to the conditions and constraints of PBD 501.

For example, a user may access PCT 502 and generate a customized insurance product using the templates, service event data with its associated enrollee data and other data from PBD 501. According to further implementations, PCT 502 may process product offering templates to generate optional riders, potential exclusions and services that are ineligible for coverage. Furthermore, PCT 502 may be configured to interpret pre-existing medical policies into standard benefit configurations using the insurance data structure (e.g., representing a policy using SEs that are defined from groups of codes that represent diagnosis, procedure, provider, and place of service).

PCT 502 may be configured to include a user interface designed for users focused on customer product sales and marketing, and may enable users to model a customer plan accurately and comprehensively. In one implementation, PCT 502 may be used to configure an insurance product while using a small number of SEs by selecting from an allowed list of values in a table-driven, constraint-based insurance data structure. Because the insurance data structure includes service events with associated ranges of allowable enrollee responsibilities and applicable service limitations (internal medical policies or state mandated benefits), and the allowed list of values are provided from the structure, the configuration of medical benefits in products can be controlled and be compliant with medical policies or mandated benefits. In addition to enabling users to configure customer plans, the PCT 502 may provide product availability grids, tracking of changes in a plan configuration, product offering template search functionalities, and/or customer plan modification functionalities.

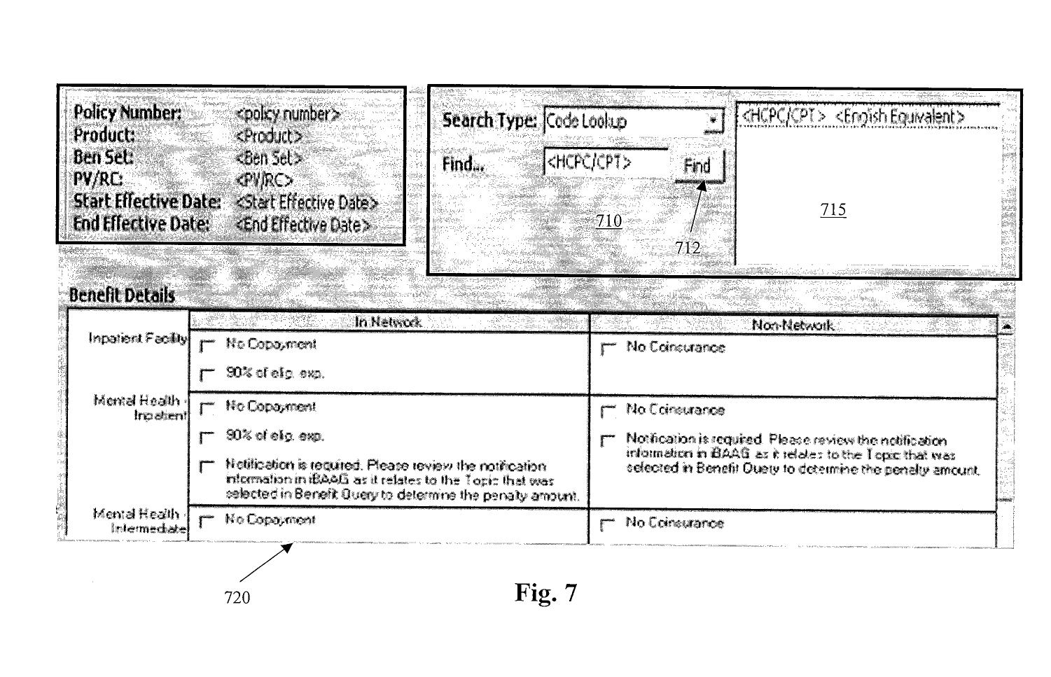

The benefit query tool 503 uses the insurance data structure or portions thereof such as the service event data to assemble benefit information, and enables a user to search benefit configurations and product availability grids, for example. A benefit query user interface may be provided for a user to enter search criteria, view benefit plan data at a central location in a summary format, and/or automatically document quoted benefits, where applicable. FIG. 7 provides an exemplary screenshot of a benefit query user interface. According to FIG. 7, a user may enter search criteria at fields 710, select the “Find” icon 712, and select a result from the results list 715. The search criteria entered may be according to type such as by code or keywords. The benefit details section 720 provides the user with benefit details related to the user's selection.

The benefit query tool 503 may be configured in a variety of ways depending on the type of query. For insurance plan and/or benefit queries, multiple search options may be provided to locate a plan and/or benefit within a particular plan in PBD 501, such as by name, policy number, benefit set and effective date for plan queries, and by keyword, code lookup, topics, medical benefits, and administrative instruction for benefit queries. For plan information queries, a user may be provided with a context about the benefit information retrieved, and the user may verify that they are quoting the correct plan, such as by reviewing a policy number, product type, benefits set, and/or a plan start and end effective date. For a benefit information queries, a user may be provided with information such as medical benefits (copays, coinsurance, limits, notification, plan liabilities), administrative information or instructions, eligibility information, and benefit summaries.

The benefit query tool 503 also may be provided in a variety of configurations depending on the targeted user. For example, for a customer service representative, the benefit query tool may appear similar to the screenshot of FIG. 7 and summarized benefit information may be provided. For a user that manually adjusts claims, the benefit query tool may provide detailed benefit information and options for the user to edit claims or benefit data associated with a policy or to change policy types. For a customer, the benefit query tool may provide a user interface that allows the customer to look up information related to their policy or a dependent's policy.

Because the insurance data structure from PBD 501 is composed of a set of service events, components using the insurance data structure are provided with the same set of data. For example, for a given SE, the same diagnosis, place of service, provider type, procedure code set, uncoded condition data, and/or enrollee responsibility data will be presented to a user regardless of the tool used, e.g. PCT or benefit query tool. In addition, because the plan configuration tool (PCT) 502, and the benefit query tool 503 use the same insurance data structure, templates, and conditions and constraints from PBD 501, a closed-loop system is provided for configuring, quoting, and selling customer products, and for translating the product information into a claim and customer query. In addition, the PBD 501 enables easy comparison of health products because each product is composed of components from the same insurance data structure regardless of the product type, e.g., private insurance, or government-sponsored insurance. Furthermore, for products that are configured based on the insurance data structure, PBD 501 and its components 502-503 may be provided with comprehensive benefit information for the products down to SE components, such as diagnosis codes.

Accordingly, the insurance data structure with its inventory of service events provides a level of abstraction that enables medical encounters to be logically grouped together, inter alia, according to their enrollee responsibilities. The insurance data structure may be a useful tool for multiple applications and may benefit insurance companies, providers, and members, as herein described.

According to certain configurations, claims adjudication systems, such as those described in U.S. Pat. No. 5,359,509, having an issue date of Oct. 25, 1994, and entitled “Health Care Payment Adjudication and Review System”, which is incorporated herein by reference in its entirety, may be implemented along with the disclosed inventive methods and systems.

In addition, claims processing systems, such as those described in U.S. patent application Ser. No. 11/562,131, having an application date of Nov. 21, 2006, and entitled “Method and System for Enabling Automatic Insurance Claim Processing”, which is incorporated herein by reference in its entirety, may be implemented along with the disclosed inventive methods and systems.

Furthermore, the disclosed inventive methods and systems be combined with customer service applications in addition to or as an alternative to the benefit query described above, such as the one disclosed in U.S. Pat. No. 6,581,067, an issue date of Jun. 17, 2003, and entitled “Method and System for Providing Administrative Support”, which is herein incorporated by reference in its entirety.

The methods according to the present invention may be implemented using paper, paperless, and/or computer methods. In some implementations, various combinations of software and hardware may be used, as would be apparent to those of skill in the art and as desired by the user. In addition, the present invention may be implemented in conjunction with a general purpose or dedicated computer system having a processor and memory components.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. For example, an insurance policy having the discount provision may be provided to a policyholder initially holding an individual policy rather than an employer-sponsored policy. References to details of particular embodiments are not intended to limit the scope of the invention.

What is claimed is:

1. A method for providing insurance data, comprising:
storing one or more service events, each service event associated with one or more medical encounters and with enrollee responsibility data;
receiving medical encounter data from a user;
identifying the service event associated with the medical encounter data received from the user; and
providing to the user the enrollee responsibility data associated with the identified service event.

2. The method of claim 1, wherein storing one or more service events comprises storing an insurance data structure comprising a service event level having the one or more service events and a covered health services level having a plurality of covered health services, each of said plurality of covered health services associated with one or more service events from the service event level.

3. The method of claim 2, wherein the one or more service events associated with each of the plurality of covered health services comprises between 1 and 50 service events.

4. The method of claim 1, wherein each medical encounter is associated with one service event.

5. The method of claim 4, wherein each of the one or more medical encounters comprises a medical encounter code, said medical encounter code associated with one or more industry standard codes.

6. The method of claim 5, wherein the medical encounter codes correspond to codes found on medical insurance claims.

7. The method of claim 1, wherein receiving medical encounter data comprises receiving an insurance claim comprising medical encounter data.

8. A method for generating insurance products, comprising:
storing one or more service events, each service event associated with one or more medical encounters and with enrollee responsibility data;
storing one or more insurance product templates, each template associated with the one or more service events for a user to select;
providing the user with access to the one or more insurance product templates and the one or more service events;
receiving service event selection data from the user; and
generating one or more insurance products using the service event selection data.

9. The method of claim 8, further comprising providing the user with a comparison of two or more of the generated insurance products.

10. The method of claim 8, wherein one of the one or more generated insurance products is a health insurance policy.

11. The method of claim 8, wherein one of the one or more generated insurance products is a health insurance rider.

12. A method for characterizing insurance products comprising:
storing one or more service events, each service event associated with one or more medical encounters and with enrollee responsibility data;
receiving insurance plan data;
characterizing the insurance plan data using the one or more service events; and
providing the characterized insurance plan data to a user.

13. The method of claim 12, wherein receiving insurance plan data comprises receiving data associated with a pre-existing insurance plan.

14. The method of claim 13, further comprising generating an insurance product based on the characterized insurance plan data.

15. The method of claim 12, further comprising providing a comparison of two or more sets of characterized insurance plan data to the user.

16. A system for providing insurance data, comprising:
a database configured for storing one or more service events, each service event associated with one or more medical encounters and with enrollee responsibility data;
a processor configured for retrieving data associated with the one or more service events; and
a plurality of user terminals for receiving the retrieved data.

17. The system according to claim 16, wherein the database is further configured for storing insurance product templates, where the insurance product templates are associated with the one or more service events.

18. The system according to claim 17, wherein the plurality of user terminals is further configured for inputting the template and associated service event selection data, and the processor is further configured for receiving template and associated service event selection data and generating an insurance product from the selection data.

19. The system according to claim 16, wherein the processor retrieves enrollee responsibility data in response to receiving an insurance benefit query.
